(19) United States
(12) Patent Application Publication
(10) Pub. No.: US 2007/0213153 A1
(43) Pub. Date: Sep. 13, 2007

(54) Mounting of a Heavy-Duty Alternator to an Automotive Engine

(75) Inventor: Kevin T. Stone, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/749,023

(22) Filed: May 15, 2007

Related U.S. Application Data
(62) Division of application No. 11/054,459, filed on Feb. 9, 2005.

(51) Int. Cl. F16H 7/12

(52) U.S. Cl. 474/133; 296/208

(57) ABSTRACT

A system that provides a belt driven Power-Take-Off (“PTO”) mounting for a heavy-duty alternator onto a lighter duty automotive engine. The system provides additional torque support for the alternator and crankshaft pulley while allowing the alternator to pivot with engine movement on the motor mounts. A belt tensioner automatically tightens a serpentine drive belt. An alternator air intake and plenum draws cooling air through ducting from outside the engine compartment.

### CROSS-REFERENCE TO RELATED APPLICATIONS

This application is a divisional of U.S. patent application Ser. No. 11/054,459 filed Feb. 9, 2005, and claims the benefit of U.S. Provisional Application 60/628,031 filed Nov. 15, 2004 under 35 U.S.C. 119(e).

### FIELD OF THE INVENTION

The field of the invention relates to a system for the mechanical mounting of a belt driven power-take-off heavy-duty alternator on the front of an automotive engine.

### BACKGROUND OF THE INVENTION

Historically, heavy duty trucks and buses use a diesel engine instead of a gasoline engine because a gasoline engine is generally less efficient, has a shorter life time, and has insufficient torque to power a vehicle of 30,000 to 40,000 lbs. However, exhaust emissions from a gasoline engine tend to be much less of a problem that those from a diesel engines. Thus, with certain gasoline engines such as, but not limited to, the Ford Triton V-10 gasoline fueled engine, the inventor has determined that it would be beneficial to use such an engine in heavy duty series hybrid-electric vehicle applications because of the much cleaner exhaust emissions. In such an application, the Ford Triton V-10 gasoline engine is part of a series hybrid where the engine is only used to power a generator and the vehicle is propelled by electric motors. The engine/generator provides high voltage power for vehicle propulsion.

However, in such applications, low voltage 12/24 volt power is still needed for low-voltage accessories and for charging low-voltage batteries. One way to provide low-voltage power is to use a high-power DC-to-DC converter connected between the high voltage buss and the low-voltage power distribution to energize the low-voltage accessories and charge the low-voltage batteries. However, the inventor has determined that a much less expensive way to provide low-voltage power with the gasoline engine is by using a standard heavy-duty alternator that is normally mounted on a heavy-duty diesel engine.

Thus, a need exists for a system for the mechanical mounting of a belt driven power-take-off heavy-duty alternator on the front of an automotive engine.

### SUMMARY OF THE INVENTION

The present invention involves a system for mounting a heavy-duty alternator to a gasoline internal combustion automotive engine. The system includes a mounting bracket assembly that extends from the engine and carries the alternator, a torque support bracket assembly that supports the turning torsion of the alternator and further supports the alternator weight while providing for engine movement on the motor mounts, a crankshaft spider pulley assembly to provide a higher PTO from the front end of the engine crankshaft, and a tensioner assembly to tension a serpentine belt that drives the alternator pulley from the crankshaft spider pulley assembly.

For applications requiring alternator cooling air at a lower temperature than available in the engine compartment, the invention design includes an optional manifold and ducting to draw air from in front of the radiator for the alternator cooling air intake. The lower cooling air temperature increases the reliability and longevity of the electrical components of the alternator assembly.

Another aspect of the invention involves a system for mounting a heavy-duty alternator to an automotive engine of a drive system. The drive system includes an automotive engine with a cranskhaft pulley driven by a crankshaft, a heavy-duty alternator with an alternator pulley driven by the crankshaft pulley via a drive belt, and an engine mounting frame that the engine is mounted to. The mounting system includes an engine mounting bracket assembly; means for attaching the mounting bracket assembly to the automotive engine; means for attaching the heavy-duty alternator to the mounting bracket assembly; a torque support bracket assembly; means for attaching the torque support bracket assembly between the heavy-duty alternator and the engine mounting frame; a belt tensioner assembly for tensioning the drive belt between the crankshaft pulley and the alternator pulley; and means for attaching the belt tensioner assembly to the engine.

A further aspect of the invention involves a system for mounting a heavy-duty alternator to an automotive engine of a drive system. The drive system includes an automotive engine with a cranskhaft pulley driven by a crankshaft, and a heavy-duty alternator with an alternator pulley driven by the crankshaft pulley via a drive belt. The mounting system includes a mounting bracket assembly that extends from the engine and carries the heavy-duty alternator; a torque support bracket assembly that supports turning torsion of the heavy-duty alternator and supports the heavy-duty alternator while allowing for engine movement; a crankshaft pulley assembly to provide a high power take off from a front end of the engine crankshaft, and a tensioner assembly to tension the drive belt that drives the alternator pulley from the crankshaft pulley assembly.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a front elevational view photograph of an hybrid-electric drive including a heavy-duty alternator mounted to a gasoline internal combustion automotive engine by an embodiment of a mounting system including a mounting bracket assembly, a torque support bracket assembly, a spider pulley assembly power-take-off (“PTO”) from the crankshaft, and a tensioner assembly to tension a serpentine belt drive that drives the alternator from the replacement crankshaft spider pulley assembly.

FIG. 2 is an enlarged perspective view photograph of the mounting system of FIG. 1, and shows a larger view of the mounting bracket assembly, the torque support bracket assembly, the crankshaft spider pulley assembly, the tensioner assembly, and the serpentine belt drive, and also shows an alternator pulley.

FIG. 3 is an enlarged perspective view photograph of the mounting system of FIG. 1, and shows a larger view of the mounting bracket assembly, the torque support bracket assembly, and the tensioner assembly of FIG. 1.

FIG. 4 is an enlarged side elevational view photograph of the mounting bracket assembly and the heavy-duty alternator of FIG. 1.

FIG. 5 is a side elevational view photograph of exemplary mounting members for the mounting bracket assembly and the tensioner assembly of FIG. 1.

FIG. 6 is an exploded perspective view of the mounting system including the mounting bracket assembly, the crankshaft spider pulley assembly, tensioner assembly, the alternator with torque support bracket assembly, and a partial perspective view of the engine of FIG. 1.

FIG. 7 is a front perspective view of an embodiment of an engine support plate and outer sleeve mounting arm of the mounting bracket assembly.

FIG. 8 is a rear perspective view of the engine support plate and outer sleeve mounting arm in FIG. 7.

FIG. 9 is a perspective elevational view photograph of an embodiment of an optional alternator cooling assembly including a cooling air manifold and air duct piping assembly mounted onto the front of the alternator.

FIG. 10 is an enlarged elevational view photograph of the alternator cooling assembly illustrated in FIG. 9, and illustrates the cooling air manifold mounted onto the front of the alternator behind the alternator pulley, and the alternator front collar bolted to the mounting arm, the torque support bracket assembly, the belt tensioner and serpentine drive belt.

FIG. 11 is an enlarged elevational view photograph of the cooling air manifold of the alternator cooling assembly illustrated in FIG. 9, and also shows the alternator pulley, serpentine belt and tensioner.

FIG. 12 is a side perspective view photograph of an embodiment of a radiator and the air duct piping assembly routing from the manifold on the front of the alternator to the opening at the front of the radiator.

### DETAILED DESCRIPTION OF A PREFERRED EMBODIMENT

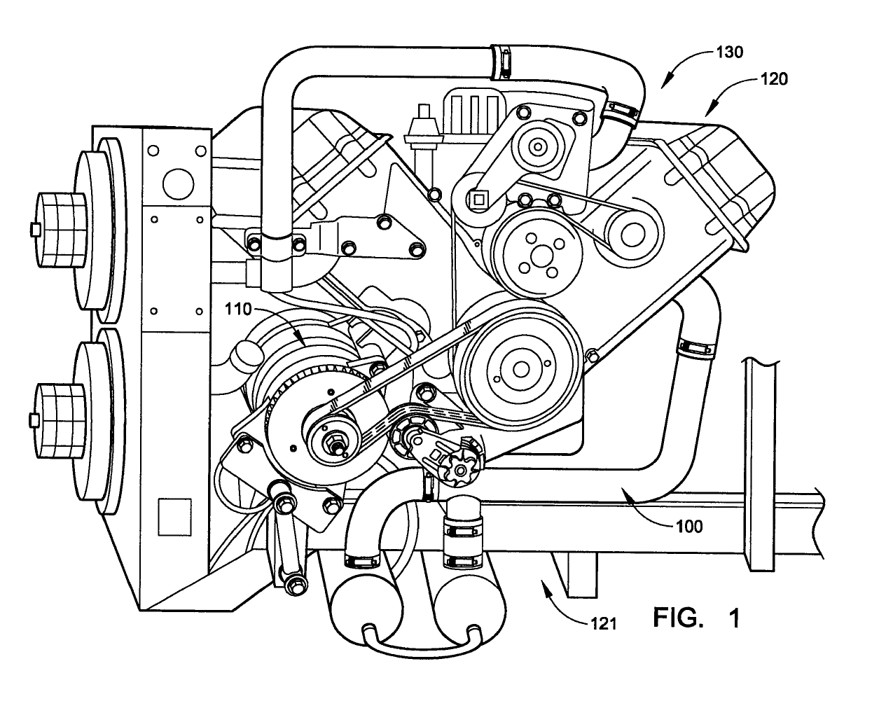

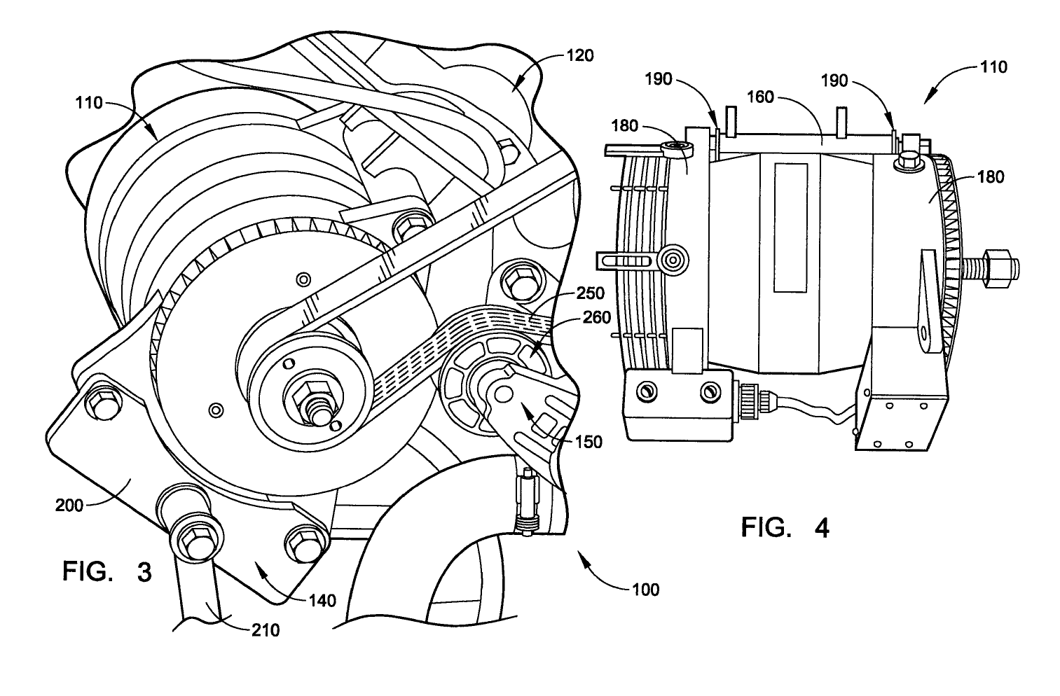

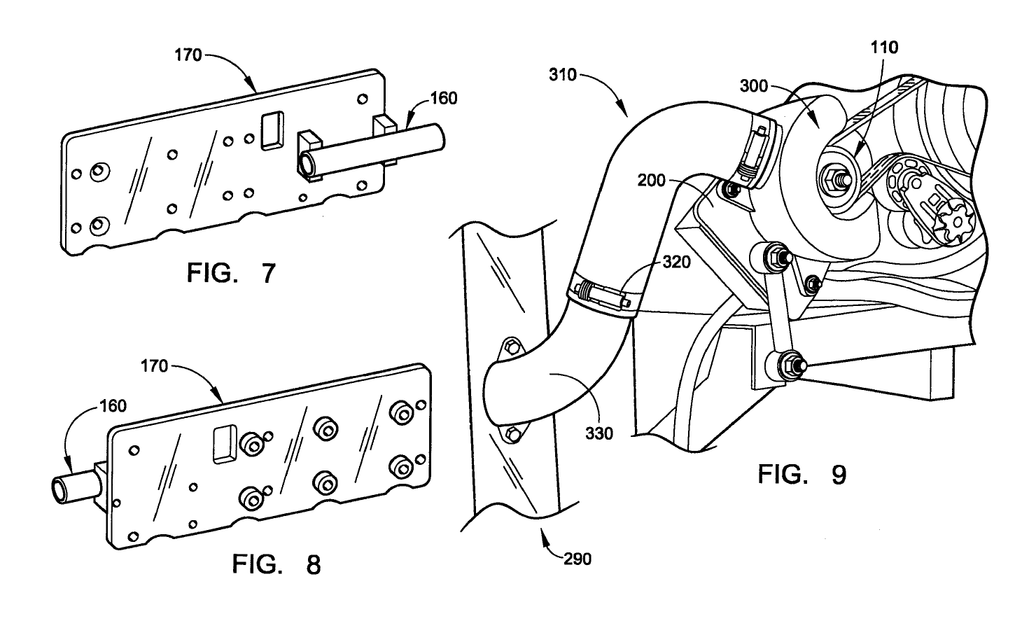

With reference to FIGS. 1-8, an embodiment of a system 100 for mounting a heavy-duty alternator 110 to a gasoline internal combustion automotive engine 120 of a series hybrid-electric drive system 130 will now be described. In the embodiment shown, the alternator 110 is a Niehoff heavy-duty alternator usually mounted on large diesel engines for buses and trucks, and the engine 120 is a Ford Triton V-10 gasoline automotive engine. In alternative embodiments, other types of alternators 110 and/or engines 120 may be used. Further, the system 100 may be used for drive systems other than series hybrid-electric drive systems, and for drive systems other than hybrid-electric drive systems.

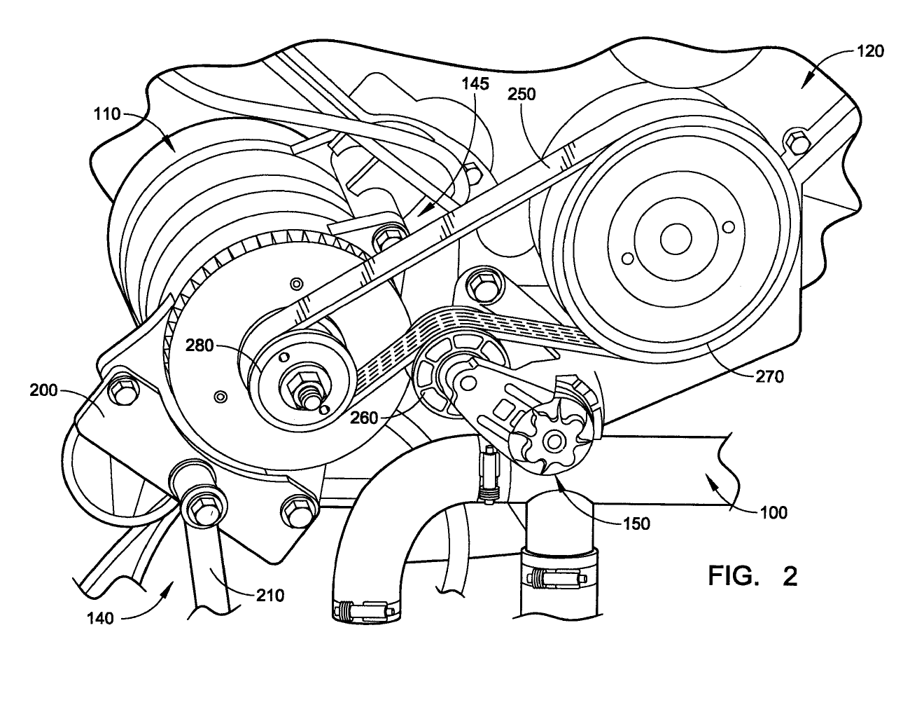

With reference to FIGS. 2-6, in the embodiment of the system 100 shown, the system 100 includes a torque support bracket assembly 140, an alternator mounting bracket assembly 145, a tensioner assembly 150, and a crankshaft spider pulley 270.

With reference to FIGS. 4-8, the alternator mounting bracket assembly 145 includes outer sleeve tube mounting arm 160, which is attached to engine support plate 170, inner sleeve tube 165, and alternator mounting bolt 166. The engine support plate 170 is mounted to the engine 120 via bolts 167. With reference to FIG. 4, collars 180 surround end portions of the alternator 110 and mount by means of the long bolt 166 to the inner sleeve tube 165 located within the outer sleeve tube mounting arm 160 at opposite ends 190 of the mounting arm 160. The inner sleeve tube 165 fits tightly within the outer sleeve tube mounting arm 160 such that the alternator 110 is allowed to pivot about the center of the two sleeve tubes 160, 165 while otherwise maintaining stability in other axes. This pivoting is necessary to accommodate movement between the engine 120 and the torque support bracket assembly 140. This movement occurs because the engine 120 is mounted to the engine support frame 121 through rubber isolation motor mounts while the torque support bracket assembly 140 is directly attached to part of the engine support frame 121.

To further accommodate this movement the torque support bracket assembly 140 attaches to the frame 121 by means of bolts inserted through rubber isolation bushings in the ends of the support arm rod 210. Vertical and torque support for the alternator 110 is provided by the torque support mounting bracket assembly 140 that consists of a bracket 200, which is connected to outer collar 180, and a support arm 210, which may be attached to the support frame 121.

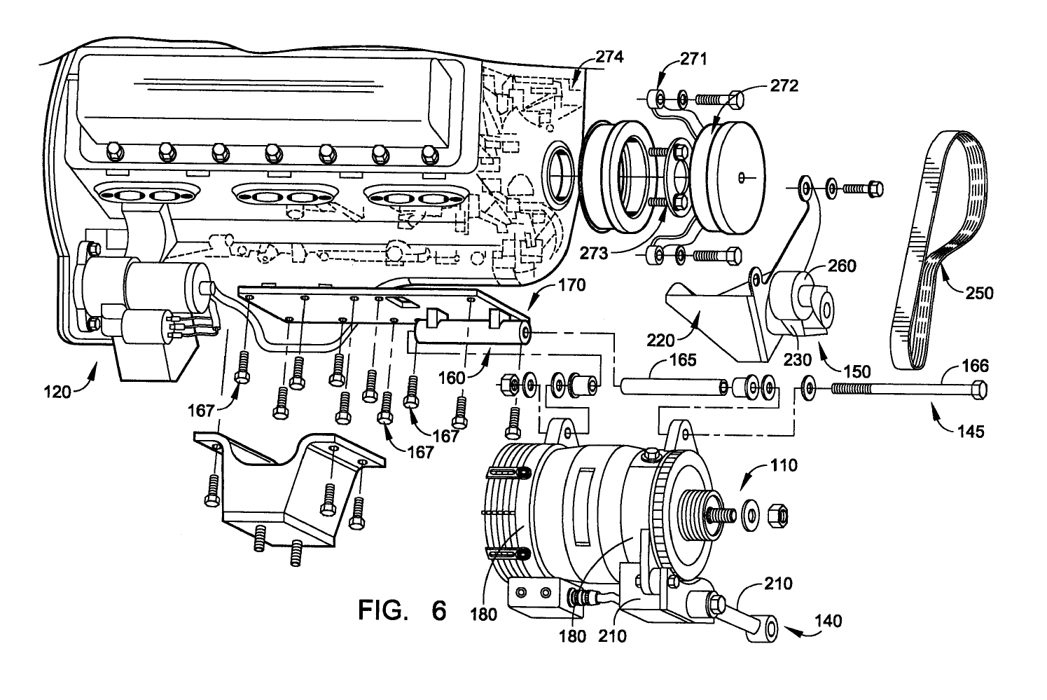

With reference to FIGS. 2 and 6, the spider crankshaft pulley assembly 270 has a “spider” support structure 271 that bolts to the engine 120 and houses the alternator crankshaft pulley 272 and bearing. A separate interface plate 273 bolts to the inside water pump pulley/harmonic balancer wheel 274 and has a threaded insert connection for attaching to the alternator crankshaft pulley 272. The spider support structure 271 and bearing provides the additional strength required for the heavy load torques of the heavy-duty alternator 110.

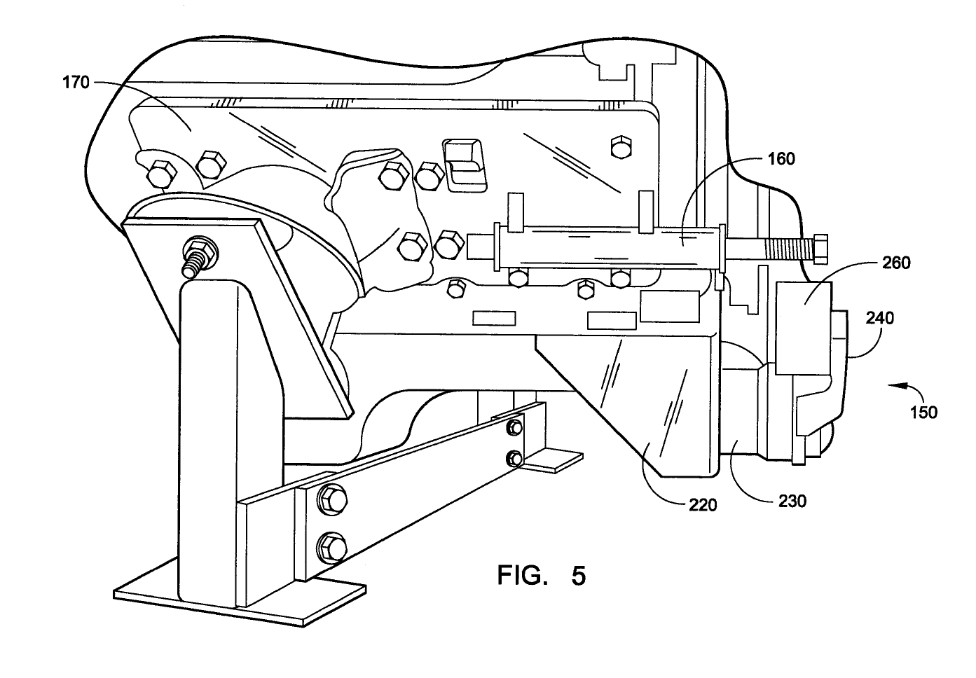

The tensioner assembly 150 is mounted to the engine 120 via mounting bracket 220 (FIGS. 5, 6). Tensioner base 230 extends outwardly from the mounting bracket 220. Tensioner arm 240 is adjustingly connected to tensioner base 230 for adjusting the tension in the serpentine belt drive 250. In an alternative embodiment the belt 250 may be a V belt. Tension pulley 260 is rotatably connected to a free end of tensioner arm 240. The serpentine belt drive or belt 250 is driven by engine crankshaft pulley 272, is tensioned through tension pulley 260, and drives alternator pulley 280 for driving the alternator 110.

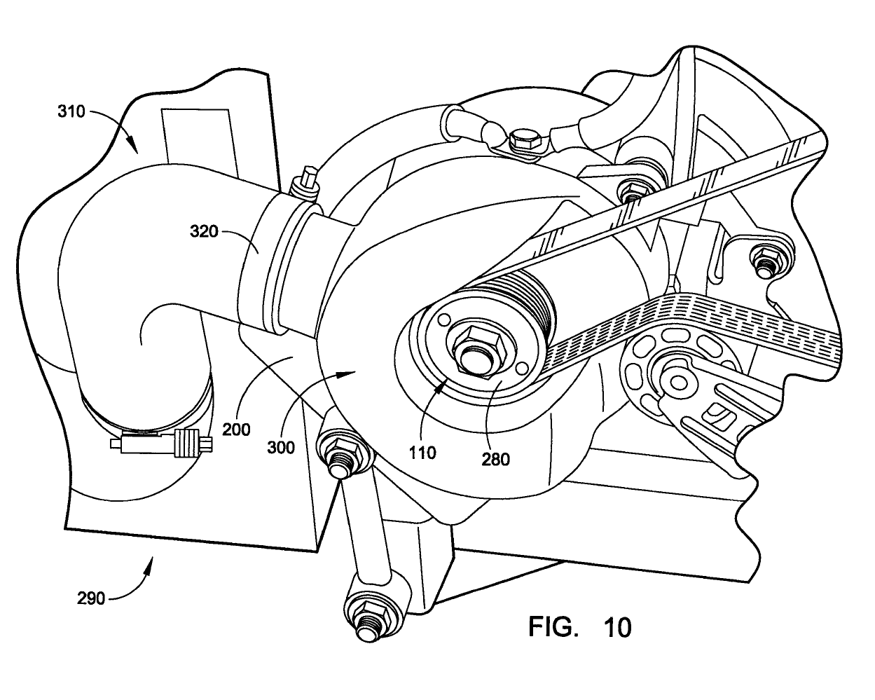

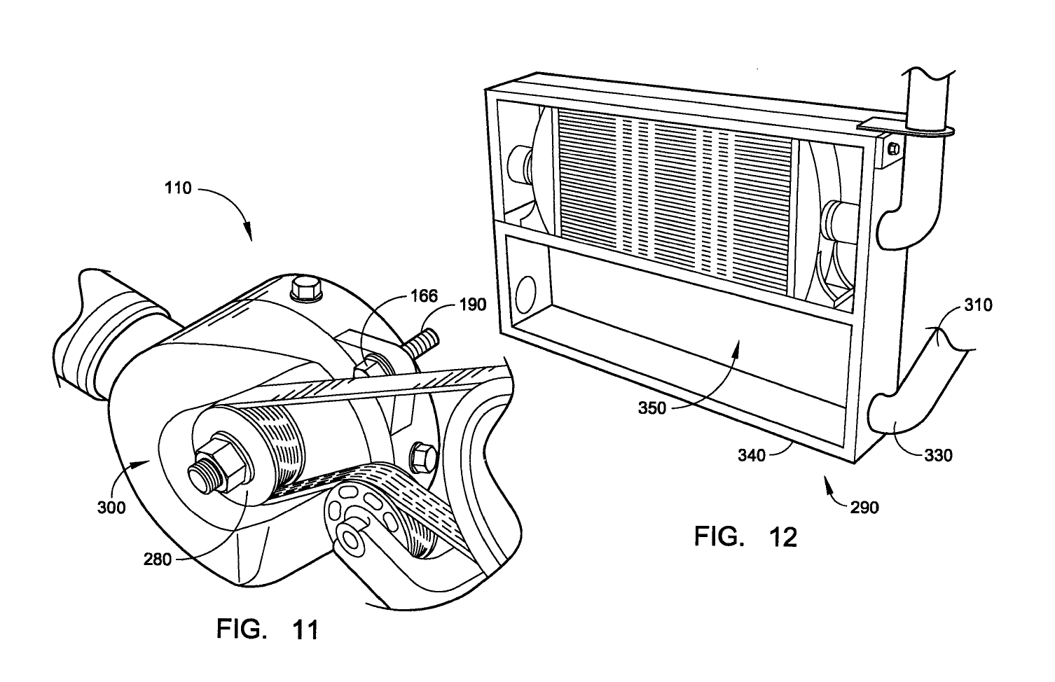

With reference to FIGS. 9-11, an embodiment of an optional alternator cooling assembly 290 will now be described. The alternator cooling assembly 290 includes an air intake manifold 300, which forms a plenum, mounted onto the front of the alternator 110 by means of the top long mounting bolt 166 at the front end 190 of the mounting arm 160 on top of the collar 180 and two other lower mounting bolts to torque support bracket 200. The manifold 300 has a fixed, round pipe extending from one side for the attachment of a curved, round, flexible, rubber air duct hose 310 with metal clamps 320. The manifold 300 includes a C-shaped raised, hollow chamber that, on the outside, provides clearance for the alternator drive pulley 280 and the drive belt 250, and, on the inside, communicates with the alternator air intake.

With reference to FIG. 12, the other end of the curved rubber air duct hose 310 is attached onto a curved, fixed metal pipe 330 with metal clamp 320. The curved metal pipe 330 extends through a hole in the radiator support mounting frame 340, at the front of radiator 350, to draw in cool air in front of the radiator 350. The curved metal pipe 330 has a welded mounting flange and is attached by bolts onto the radiator support mounting frame 340.

The system 100 for mounting a heavy-duty alternator 110 to a gasoline internal combustion automotive engine 120 allows the heavy-duty alternator 110 to be driven by, mounted to, and used with the cleaner-emission gasoline engine 120. The gasoline engine 120 is much lighter than a heavy-duty diesel engine and is not designed to accommodate the mounting of the heavy-duty alternator 110. The standard heavy-duty alternator 110 may then be used to provide low-voltage 12/24 volt power for low-voltage accessories and for charging low-voltage batteries. The system 110 provides the additional torque support for the alternator 110 and for the crankshaft pulley 272 causes by the higher power-take-off (“PTO”) of the heavy-duty alternator 110. The system 100 positions the alternator 110 and provides additional weight and torsion support without the engine movement and motor mount system affecting the mounting support.

It will be readily apparent to those skilled in the art that still further changes and modifications in the actual concepts described herein can readily be made without departing from the spirit and scope of the invention as defined by the following claims.

What is claimed is:

1. A system for mounting a heavy-duty alternator to an automotive engine of a drive system, the drive system including an automotive engine with a crankshaft pulley driven by a crankshaft, a heavy-duty alternator with an alternator cooling intake and an alternator pulley driven by the crankshaft pulley via a drive belt, and an engine mounting frame that the engine is mounted to, comprising:
an engine mounting bracket assembly;
means for attaching the mounting bracket assembly to the automotive engine;
means for attaching the heavy-duty alternator to the mounting bracket assembly;
a torque support bracket assembly;
means for attaching the torque support bracket assembly between the heavy-duty alternator and the engine mounting frame;
a belt tensioner assembly for tensioning the drive belt between the crankshaft pulley and the alternator pulley;
means for attaching the belt tensioner assembly to the engine; and
an alternator cooling assembly including a manifold and air ducting configured to attach a radiator mounting frame to the alternator cooling air intake.

2. The system of claim 1, wherein the manifold includes a C-shaped hollow chamber and the air ducting pulls in air from outside the engine compartment.

3. A system for mounting a heavy-duty alternator to an automotive engine of a drive system, the drive system including an automotive engine with a crankshaft pulley driven by a crankshaft, and a heavy-duty alternator with an alternator cooling intake and an alternator pulley driven by the crankshaft pulley via a drive belt, comprising:
a mounting bracket assembly that extends from the engine and carries the heavy-duty alternator;
a torque support bracket assembly that supports turning torsion of the heavy-duty alternator and supports the heavy-duty alternator while allowing for engine movement;
a crankshaft pulley assembly to provide a high power take off from a front end of the engine crankshaft, a tensioner assembly to tension the drive belt that drives the alternator pulley from the crankshaft pulley assembly; and
an alternator cooling assembly including a manifold and air ducting configured to attach a radiator mounting frame to the alternator cooling air intake.

4. The system of claim 3, wherein the manifold includes a C-shaped hollow chamber and the air ducting pulls in air from outside the engine compartment.
